(19) United States
(12) Patent Application Publication
(10) Pub. No.: US 2011/0221610 A1
(43) Pub. Date: Sep. 15, 2011

(54) Smart chip radio

(76) Inventor: Danae Abreu, Hacienda Heights, CA (US)

(21) Appl. No.: 12/932,969

(22) Filed: Mar. 10, 2011

Related U.S. Application Data
(60) Provisional application No. 61/340,075, filed on Mar. 11, 2010.

(51) Int. Cl. G08G 1/0965

(52) U.S. Cl. 340/902

(57) ABSTRACT

The present invention, the Smart Chip Radio, provides a smart chip or electronic sensor into a vehicle's audio system. This chip or sensor senses the siren of an approaching emergency vehicle even when the driver cannot. It then either reduces the audio system's volume or shuts down the audio system until the siren is fully audible to the driver, and the danger has passed. Thus, the car's Smart Chip Radio system knows of an emergency vehicle's approach, and turns down or turns off the on-board audio equipment to alert the driver to the approach of the emergency vehicle.

### CLAIM OF PRIORITY

This patent application claims priority under 35 USC 119(e)(1) from U.S. Provisional Patent Application Ser. No. 61/340,075 filed Mar. 11, 2010, of common inventorship herewith entitled, “Smart Chip Radio.”

### FIELD OF THE INVENTION

The present invention pertains to the field of warning devices, and more specifically to the field of automotive emergency warning devices.

### BACKGROUND OF THE INVENTION

The prior art has put forth several designs for automotive emergency warning devices. Among these are:

U.S. Pat. No. 5,278,553 to Robert H. Cornett and Jeffrey I. Berlin describes a method and apparatus for warning a motor vehicle operator of an approaching emergency motor vehicle having a sounding siren. The method comprehends selecting two frequencies A′-B′ that fall within the siren frequency range and providing a microphone for detecting the sound signals including the siren signals and filtering out the electrical siren signals by a band pass filter. The selected A′ and B′ frequency signals are individually detected to provide output indications thereof representative of an A′-B′ frequency transition. The output indications are processed for determining the preselected number of frequency transitions and producing a warning signal representative of the approaching emergency vehicle. The warning signal is utilized to give the motor vehicle operator an audible alarm and/or a visible alarm and de-energizing the motor vehicle's sound system.

U.S. Pat. No. 5,515,026 to Roger D. Ewert describes a complete vehicle accident prevention system utilizing electromagnetic transmissions for the purpose of: 1) alerting drivers to the presence of certain unanticipated accident threats such as pedestrians, bicyclists, joggers, emergency vehicles, disabled vehicles, etc.; 2) alerting people using the roadway that a vehicle is approaching thereby inducing them to move to the side of the road. The system also utilizes a speaker assembly mounted on the vehicle to forwardly transmit a pre-programmed array of natural sounds having a frequency audible to the typical human ear for the purpose of inducing animals and people to vacate the path of the approaching vehicle. The controller may receive data from a radio direction finder to cause the display to indicate to the driver of the vehicle the relative position of a potential road hazard.

U.S. Pat. No. 5,739,767 to Asia Carr describes the present invention which relates to a vehicle warning system device that is capable of detecting sirens of approaching emergency vehicles. This device includes a plurality of siren detectors, each siren detector capable of generating status signal at an output of each siren detector when activated by a siren. A plurality of visual indicators and a speaker. A microprocessor having a microprocessor plurality of input, a microprocessor plurality of output and a microprocessor memory, the microprocessor plurality of input connected to each output of the plurality of siren detectors, the microprocessor plurality of output connected both to the speaker and an input of each of the plurality of visual indicators.

None of these prior art references describe the present invention.

### SUMMARY OF THE INVENTION

It is an object of the present invention to provide a vehicular warning device that alerts drivers of nearby emergency vehicles.

### BRIEF DESCRIPTION OF THE DRAWINGS

FIG. 1 is an elevational angled perspective view of the device of the present invention.

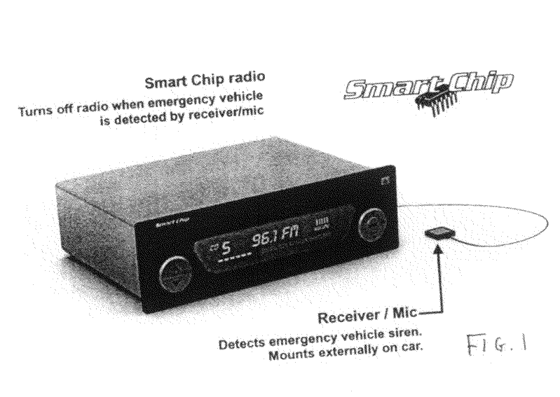

### DETAILED DESCRIPTION OF THE INVENTION

Many people have been startled and alarmed to find an emergency vehicle, an ambulance, police car, state trooper or fire truck, suddenly approaching and passing them at high speed. It's a scary thing. In the moments following such a scare, as they tremble with the adrenaline rush and realize they might have been killed, they also realize they never even heard the siren. I couldn't hear it over the sound of my radio. A substantial number of motorists every year, the ones who make a lane-change or enter an intersection oblivious to that approaching siren that they cannot hear, pay for their inattention with their lives. In 1998, according to the National Safety Council, over 32,000 crashes occurred involving ambulance, fire, police, and other emergency vehicles. It's a big problem, and with modern cars, vans, SUV's, vans and trucks featuring sound-proofing, 8-speaker 100-watt factory stereo sound systems, high volume air conditioning fans, cell phones and console phones, etc., it is no wonder that drivers won't get out of the way of what they cannot hear.

The present invention, hereinafter referred as the Smart Chip Radio was conceived in order to alert drivers to the approach of emergency vehicles, even when they cannot hear the approaching vehicle's siren. Simply stated, the Smart Chip Radio introduces a smart chip or electronic sensor into a vehicle's audio system. This chip or sensor senses the siren of an approaching emergency vehicle even when the driver cannot. It then either reduces the audio system's volume or shuts down the audio system until the siren is fully audible to the driver, and the danger has passed. Thus, the car's Smart Chip Radio system knows of an emergency vehicle's approach, and turns down or turns off the on-board audio equipment to alert the driver to the approach of the emergency vehicle. In other embodiments even handheld cell phones are turned down.

The first embodiment of the Smart Chip sensor has the sensor programmed to respond to sound in only the specific wavelengths and frequencies emitted by the sirens of emergency vehicles. Another embodiment has the sensor programmed to hear not the actual siren, but a silent, frequency-specific radio signal emitted continuously by the emergency vehicle, along with its siren. This embodiment is preferable in terms of clarity and reliability due to the potential for interference and confusion between the frequencies and wavelengths of sound being produced by the car's radio or audio system and those of the audible siren.

The Smart Chip Radio system has two basic components, a transmitter in the emergency vehicle, and a receiver/sensor in the civilian vehicle. Emergency vehicles are equipped with an automatic, silent transmitter that transmits a radio signal in a specific frequency whenever the siren and/or beacon lights were in use. This radio signal is received by corresponding sensor/receivers installed in other vehicles, and when received, the signal prompts the sensor to activate a switch, either reducing the volume of the car's on-board audio components, radio, stereo, console cell phone, etc. or turning them off entirely, in a second embodiment, as long as the siren signal is being received. In either embodiment the concept is equally well-founded and relatively simple. The approaching emergency vehicle transmits and other vehicles receive the signal and then become quiet enough that their drivers can hear the approaching siren and act accordingly. The siren-activated radio transmitter of the emergency vehicle requires a specific frequency not carrying other voice or data transmissions, and broadcasts a signal of relatively weak strength and coverage, a half-mile, three-quarters of a mile, or a mile in diameter depending on the locale, enough to warn the vehicles in its vicinity, but not so large as to disturb more distant traffic. The Smart Chip Radio is readily adaptable to existing wireless electronic and cellular technology and the system is installed as factory equipment in new vehicles, or installed by a competent automotive electronics technician as an after-market upgrade for existing vehicles. The Smart Chip Radio is produced by association between the Motor Vehicle Parts and Accessories industry, Standard Industrial Code 3669, and the Miscellaneous Communications Equipment industry, Standard Industrial Code 3669.

The Smart Chip Radio, a system to warn drivers of approaching emergency vehicles by temporarily turning down or shutting off their radios and other on-board audio components, saves lives by alerting drivers to the approach of high-speed emergency vehicles whose sirens they might not otherwise hear. The product of this invention functions automatically, in one of two ways, programmed or attuned to hear the audible siren of the emergency vehicle even when the motorist doesn't or the emergency vehicle transmits a silent radio signal anytime its siren and/or beacon lights are activated, and the Smart Chip is programmed to sense and respond to that signal. With either embodiment, once the Smart Chip detects an approaching siren it responds, electronically and automatically, by turning down or shutting off the car's audio components until the emergency vehicle has passed. In this time of increasingly sound-proof vehicles, high-watt audio systems, and cell phones, there are few of us on the road who haven't had the experience of being scared half to death by the sudden approach of an emergency vehicle, and few of us who haven't considered that the consequences could have been disastrous. As drivers, we simply do not hear sirens as we once did. And this fact is not a danger only to us and our passengers, but also to the emergency vehicles and their passengers, police, fire and EMS personnel, as well as accident victims and emergency medical cases being transported in a hurry. Clearly, then, both the nation's emergency responders, and the nation's motoring public, have a great need for the Smart Chip Radio.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An automotive emergency warning device, comprising: a smart chip or electronic sensor for insertion into a vehicle's audio system, wherein the chip or sensor senses the siren of an approaching emergency vehicle and either reduces the audio system's volume or shuts down the audio system until the siren is fully audible to the driver, and the danger has passed.

2. The device of claim 1 wherein the sensor is programmed to respond to sound in only the specific wavelengths and frequencies emitted by the sirens of emergency vehicles.

3. The device of claim 1 wherein the sensor is programmed to hear not the actual siren, but a silent, frequency-specific radio signal emitted continuously by the emergency vehicle, along with its siren.

4. The device of claim 1 comprising a transmitter in the emergency vehicle, and a receiver sensor in the civilian vehicle, wherein the emergency vehicle is equipped with an automatic, silent transmitter that transmits a radio signal in a specific frequency whenever the siren or beacon lights are in use, and wherein the radio signal is received by corresponding sensor receivers installed in other vehicles, and when received, the signal prompts the sensor to activate a switch, either reducing the volume of the car's on-board audio components, radio, stereo, console cell phone, or turning them off entirely.

5. The device of claim 4, wherein the device operates as long as the siren signal is being received.

6. The device of claim 4, wherein the approaching emergency vehicle transmits and other vehicles receive the signal and then become quiet enough that their drivers can hear the approaching siren and act accordingly, and wherein the siren-activated radio transmitter of the emergency vehicle requires a specific frequency not carrying other voice or data transmissions, and broadcasts a signal of relatively weak strength and coverage, a half-mile, three-quarters of a mile, or a mile in diameter depending on the locale, enough to warn the vehicles in its vicinity, but not so large as to disturb more distant traffic.

7. The device of claim 4 wherein the device is adaptable to existing wireless electronic and cellular technology and the system is installed as factory equipment in new vehicles.

8. The device of claim 4 wherein the device is installed by a competent automotive electronics technician as an after-market upgrade for existing vehicles.
